(19) United States
(12) Patent Application Publication
(10) Pub. No.: US 2002/0120446 A1
(43) Pub. Date: Aug. 29, 2002

(54) Detection of inconsistent training data in a voice recognition system

(75) Inventor: David E. Chevalier, Muskego, WI (US)

Correspondence Address: Motorola, Inc., Randall S. Vaas - AN475, Intellectual Property Dept. (BMM), 600 North US Highway 45, Libertyville, IL, 60048, US

(73) Assignee: Motorola, Inc.

(21) Appl. No.: 09/792,532

(22) Filed: Feb. 23, 2001

(51) Int. Cl. G10L 15/00

(52) U.S. Cl. 704/246

(57) ABSTRACT

A method for detecting inconsistent voice training in a speech recognition system includes a first step (202) of inputting data representing a first spoken phrase and a second spoken phrase defining a voice recognition training pair. A next step (206) includes comparing a representation of the training pair with a collection of data of previously stored valid training pairs. A next step (210) includes testing the comparison from the comparing step against a predetermined threshold to determine if the representation of the training pair is consistent. A next step (216) includes storing a combined representation of the training pair as a valid training pair if the training pair is found consistent.

### FIELD OF THE INVENTION

This invention relates generally to speech recognition systems, and more particularly to a system for detecting inconsistent voice training.

### BACKGROUND OF THE INVENTION

Recently, wireless communication systems, such as cellular telephones for example, have included voice recognition systems to enable a user to enter a digit or digits of a particular number upon vocal pronunciation of that digit or digits. Further, a user can direct the telephone to dial an entire telephone number upon recognition of a simple voice-coded command, i.e. voice activated dialing (VAD). For example, a user can have the telephone automatically dial a particular party upon a vocal input of that party's name or other command. In order to effectuate the recognition of a vocal input, the telephone must be trained to recognize the vocal input. This is accomplished by speaking the command to the phone and having the phone store the command in memory along with the associated telephone number for future comparison. Afterwards, when the user wishes to call that party, the user vocalizes the name or command for the party, the telephone compares that vocalized input against those stored in the memory and when a correct match is found the telephone dials the associated telephone number.

A problem arises where a user does not repeat a voice command in the same way every time. This involves changes in tone, pitch, amplitude, and timing among other parameters. In such a case, the telephone may not properly recognize the command, or it may recognize the command incorrectly by matching it to a similar but different phrase. Therefore, training techniques have arisen where a user repeats a command phrase so that the telephone can store an average model for that phrase as spoken by the particular user. In this way, the probability for a correct match is increased by accounting for variances in the spoken word by any particular user.

Prior art methods to accomplish training involves have a user repeat a voice command twice. The two utterances are first compared with each other to see if they are consistent. The utterances are then compared to each of the previous stored utterances to ensure that they would not be confused (i.e. are not consistent) with any of the previously stored utterances. However, this procedure basically measures a percentage difference between compared utterances, which can still result in; a proper command being confused with an incorrect stored utterance, a proper command not being recognized, and an improper command being accepted.

What is a needed is a voice recognition system that improves the determination of inconsistent commands while reducing the number of false detections. It would also be of benefit to use statistical comparisons of all stored utterances to demonstrate consistency. In addition, it would be of benefit to provide a comparison against inconsistent speech to further improve performance.

### BRIEF DESCRIPTION OF THE DRAWINGS

FIG. 1 shows a simplified block diagram for a voice recognition apparatus, in accordance with the present invention;

FIG. 2 shows a block diagram of a method for voice recognition improvement provided by the present invention; and

FIG. 3 shows a graphical representation of the performance improvement provided by the present invention.

### DETAILED DESCRIPTION OF THE PREFERRED EMBODIMENT

The present invention provides an apparatus and method to detect and reject inconsistent training pair utterances. This is accomplished by comparing the consistency of statistics of input training speech against the class statistics of previously stored speech, including the statistics of utterances that are not similar to the input speech. Moreover, the present invention utilizes the statistics of previously stored inconsistent speech to further enhance voice recognition accuracy.

The invention will have application apart from the preferred embodiments described herein, and the description is provided merely to illustrate and describe the invention and it should in no way be taken as limiting of the invention. While the specification concludes with claims defining the features of the invention that are regarded as novel, it is believed that the invention will be better understood from a consideration of the following description in conjunction with the drawing figures. As defined in the invention, a radiotelephone is a communication device that communicates information to a base station using electromagnetic waves in the radio frequency range. In general, the radiotelephone is portable and is able to receive and transmit.

The concept of the present invention can be advantageously used on any electronic product interacting with audio or voice signals. Preferably, the radiotelephone portion of the communication device is a cellular radiotelephone adapted for personal communication, but may also be a pager, cordless radiotelephone, or a personal communication service (PCS) radiotelephone. The radiotelephone portion generally includes an existing microphone, speaker, controller and memory that can be utilized in the implementation of the present invention. The electronics incorporated into a cellular phone, two-way radio or selective radio receiver, such as a pager, are well known in the art, and can be incorporated into the communication device of the present invention.

Many types of digital radio communication devices can use the present invention to advantage. By way of example only, the communication device is embodied in a cellular phone having a conventional cellular radiotelephone circuitry, as is known in the art, and will not be presented here for simplicity. The cellular telephone, includes conventional cellular phone hardware (also not represented for simplicity) such as processors and user interfaces that are integrated in a compact housing, and further includes memory, analog audio and digital circuitry such as analog-to-digital converters and digital signal processors that can be utilized in the present invention. Each particular wireless device will offer opportunities for implementing this concept and the means selected for each application. It is envisioned that the present invention is best utilized in a digital cellular telephone using Viterbi decoding.

A series of specific embodiments are presented, ranging from the abstract to the practical, which illustrate the application of the basic precepts of the invention. Different embodiments will be included as specific examples. Each of which provides an intentional modification of, or addition to, the method and apparatus described herein. For example, the case of a cellular telephone is presented below, but it should be recognized that the present invention is equally applicable to home computers, mobile or automotive communication or control devices or other devices that have a human interface that could be adapted for voice operation. In the description below, any vector or matrix quantities (.)^{T}, (.)⁻¹, |.| represent the transposition, inversion and determinant of the vectors or matrices, respectively.

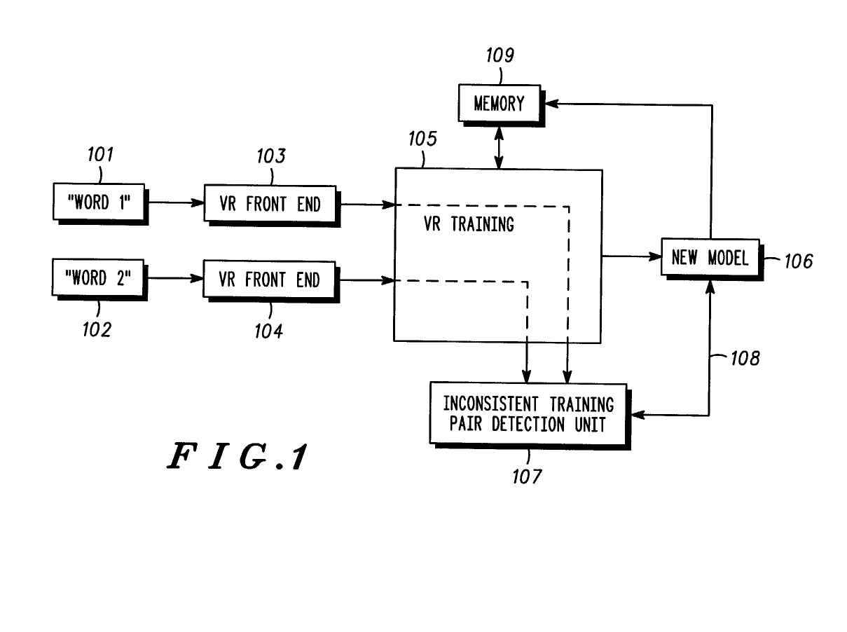

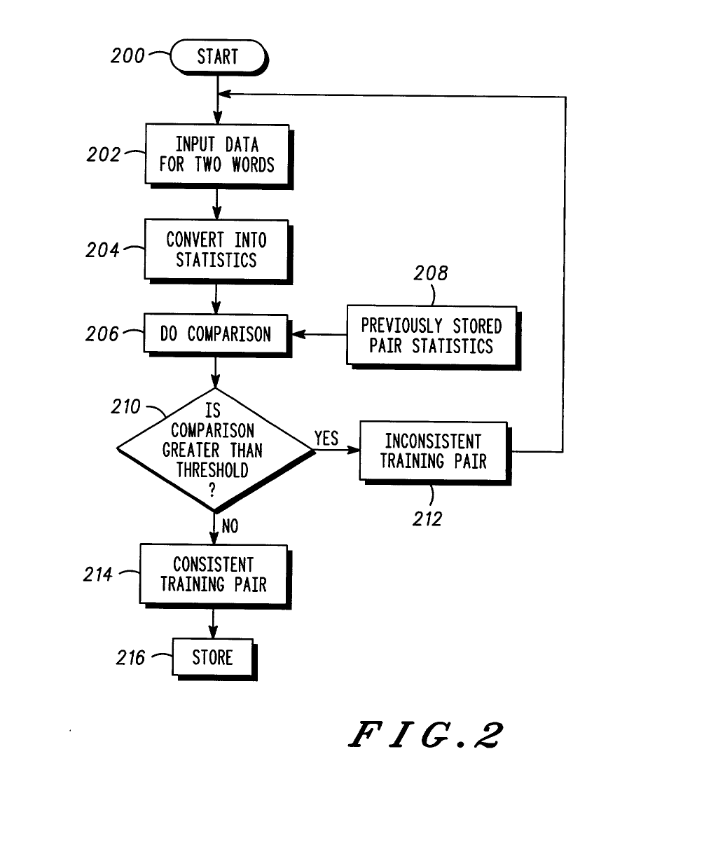

FIGS. 1 and 2 show a simplified representation of the voice recognition method and apparatus for detecting inconsistent voice training in a speech recognition system, in accordance with the present invention. At a beginning 200, a voice recognition training procedure takes a first and second spoken phrase 101,102 or words, defining a voice recognition training pair, and inputs 202 the data representing the two spoken phrases 101,102 into a receiver 103,104 or voice recognition front end. Typically, this is accomplished by transducing audio signals into an electrical signal by a microphone. This electrical signal can be converted into digital signals by an analog to digital converter. Alternatively, the electrical signal can be obtained via a modulated RF signal from the radiotelephone. These techniques are known and will not be presented here.

The receiver 103,104 outputs a representation of the training pair. In particular, the receiver 103,104 converts 204 the training pair into separate feature sets. The feature sets are vectors of mel-filtered cepstral coefficients (MFCC), as are known in the art. Specifically, the feature sets are determined from the Viterbi path scores for each of the training pairs. These scores are derived from the resulting distances between an aligned Viterbi state mean and the feature state mean of each word of the pair within each frame of the input signal, the Viterbi state mean being a new model 106 that is obtained from aligning the training pairs. Therefore, each frame score is obtained from the distance between a mean state within said frame for the actual input and that of a Viterbi aligned signal. The sum of each of these distances is taken over all the frames of the input word signal to obtain the Viterbi score for that word. Subsequently, the Viterbi path score as determined for each of the separate feature sets defines a feature vector X=[x₁, x₂]^{T} where x₁ and x₂ are the respective Viterbi path scores of the associated feature sets of the training pair.

A comparator 105 inputs the representation (feature vector) of the training pair from the receiver 103,104. The comparator 105 compares 206 the representation of the training pair with class statistics 208, derived from a collection of data of training pairs, and previously stored in the memory 109. The class statistics 208 comprises mean and covariance statistics, M, defined as a mean vector of the previously stored training pairs, and, Σ, the covariance matrix of the previously stored training pairs. These previously stored pairs include pairs that were found to be consistent, even though they can be very dissimilar utterances than the training pair to be tested. Surprisingly, it has been found that the statistics as described above are very similar for consistent pairs, and transcend differences in words or speakers. In other words, the statistics as described above are substantially independent of the utterances themselves or the user's voice qualities. As a result, these statistics can be used advantageously to determine consistency using very different types of utterances. For example, if the mean and covariance statistics of the training pair are similar to the mean and covariance of previously stored consistent pairs, then the training pair is also consistent. Moreover, the larger the number of previously stored pairs available the better the quality of a consistency decision.

The comparator 105 then outputs a comparison value

(X−M)^{T}Σ⁻¹(X−M)

where Σ is a diagonalized covariance matrix of the class statistics of the previously stored consistent training pairs, and as described above.

A detector 107 inputs the comparison and tests it 210 against a predetermined threshold to determine if the representation of the training pair is consistent. For example, if the difference between a consistent pair and the training pair is less than or equal to the threshold, then the training pair is deemed consistent, and if the difference between a consistent pair and the training pair is greater than the threshold, then the training pair is deemed inconsistent. The threshold itself is fixed, but can be variable in response to external affects such as ambient noise conditions, for example. Further, it was found that a single, fixed threshold is adequate to use for very different voice commands. Choosing the actual threshold value is dependent on the acceptable amount of error, as will be explained below.

If the representation of training pair is found consistent 214, a combined representation of the training pair is provided 108 as a new model 106 and is stored 216 in the memory 109 as a valid training pair. The new model is generally of the form of a Hidden-Markov model, as is known in the art, which consists of a set of states and associated transition probabilities. Each state represents an average of a selected portion of the two input feature sets. If the representation of the training pair is not found consistent 212 then more inputs must be sampled.

In a preferred embodiment, the present invention also takes into account previously stored values of inconsistent statistical data in the comparison 206. In this case, a Viterbi path score is determined 204 for each of the separate feature sets of the training pairs to define a feature vector X=[x1, x2, y1, y2]^{T} where x1 and x2 are the respective Viterbi path scores of the associated feature sets of the training pair as described before, and y1 and y2 are reference path scores determined by measuring the total accumulated distance from the origin in the MFCC vector space. These reference path scores, y1 and y2, provide additional information about the consistency of the two input utterances, beyond that provided by the new model alignment scores x1 and x2. The collection of data of previously stored training pairs now includes a mean vector, M₁, of previously stored consistent training pairs and a mean vector, M₂, of previously stored inconsistent training pairs. The comparison is now

a(X−M₁)^{T}Σ₁⁻¹(X−M₁)−b(X−M₂)^{T}Σ₂⁻¹(X−M₂)+c(log(|Σ₁|/|Σ₂|)

where a, b, c are constants, Σ₁ is a covariance matrix of class statistics of the previously stored consistent training pairs, and Σ₂ is a covariance matrix of class statistics of the previously stored inconsistent training pairs. Preferably, a, b and c are all values of 0.5. The detector 107 inputs the new comparison and tests it 210 against the threshold and determines consistency in the same way as explained previously. The use of the class of inconsistent data provides a further improvement in the performance of the voice recognition system as will be shown below.

### EXAMPLE

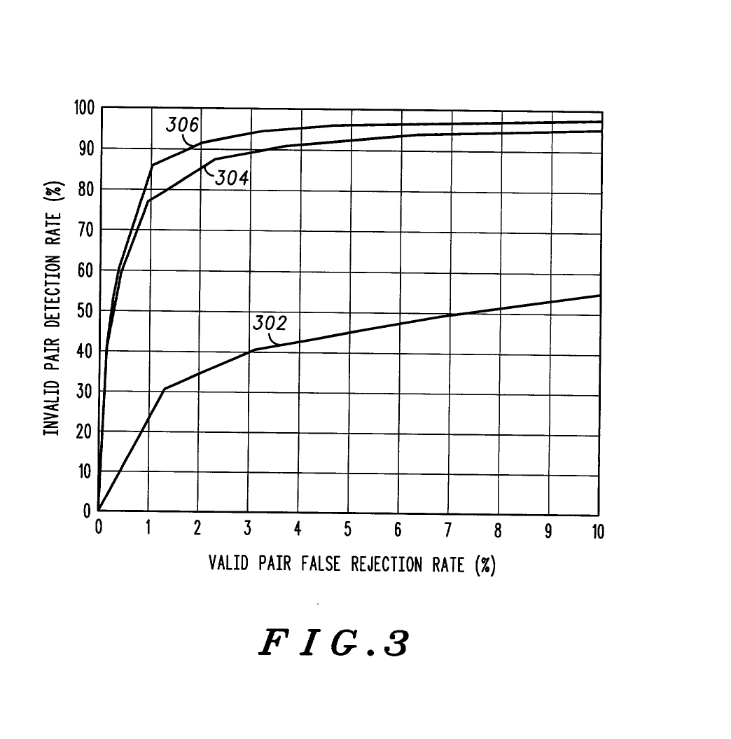

A numerical simulation was performed using the voice recognition techniques of the present invention, in comparison to the prior art “percent difference” method. The results are provided in FIG. 3. From a statistical point of view two significant types of errors can occur from voice recognition method; the acceptance of an incorrect command and the rejection of a correct command. In the former case, the voice recognition system determines that a training pair is valid when it is not. In the latter case, the voice recognition system determines that a training pair is invalid when it is should have been accepted as valid. By choosing the threshold value properly, a successful tradeoff can be made wherein the present invention provides improved invalid pair detection at a reduced valid pair false rejection rate over the prior art method. In practice a threshold of about 1.6 is chosen.

FIG. 3 shows a chart of the results of a simulation of invalid pair detection rate (correct rejection) versus valid pair false rejection (incorrect rejection) for the present invention over the prior art method. The same simulated signal was used in each case. Curve 302 represents the performance of the prior art method wherein a percent difference is taken between utterances and compared against a threshold. Curve 304 represents the performance of the first embodiment of the present invention wherein utterances are compared against the class statistics of stored consistent utterances, as described previously. Curve 306 represents the performance of the preferred embodiment of the present invention wherein utterances are compared against the class statistics of stored consistent utterances and inconsistent utterances, as described previously. As can be seen, the present invention provides improved correct rejections (invalid pair detections) at any particular rate of incorrect rejections (valid pair false rejections) over the prior art method, with the preferred embodiment of the present invention providing the best performance. In particular, the present invention is seen to achieve greater than 90% accuracy at a falsing rate of about 2%. In comparison, the simple percent difference method of the prior art is only able to achieve 35% accuracy at this same falsing rate.

The present invention also includes a method for detecting inconsistent voice training in a speech recognition system. In its simplest embodiment, and referring to FIG. 2, the method comprises a first step 202 of inputting data representing a first spoken phrase and a second spoken phrase defining a voice recognition training pair. Specifically, the representation of the training pair is provided by a step 204 of converting the training pair into separate feature sets. More specifically, the converting step includes determining a Viterbi path score for each of the separate feature sets to provide a feature vector representation of the training pair. In particular, the converting step includes determining a Viterbi path score for each of the separate feature sets to define a feature vector X=[x₁, x₂]^{T} where x₁ and x₂ are the respective Viterbi path scores of the associated feature sets of the training pair. However, in a preferred embodiment, the converting step includes determining a Viterbi path score for each of the separate feature sets to define a feature vector X=[x₁, x₂, y₁, y₂]^{T} where x₁ and x₂ are the respective Viterbi path scores of the associated feature sets of the training pair, and y₁, and y₂ are reference path scores.

A next step 206 includes comparing a representation of the training pair with a collection of data of previously stored training pairs 208. Specifically, the collection of data of previously stored consistent training pairs, M (or M₁), is defined by a mean vector of the previously stored consistent training pairs. Preferably, the mean vector also includes statistical data, M₂, on previously stored inconsistent training pairs. More specifically, the comparing step 206 includes the comparison (X−M)^{T}Σ⁻¹(X−M) where Σ is a diagonalized covariance matrix of class statistics of the previously stored consistent training pairs. However, in a preferred embodiment, the comparing step 206 includes the comparison a(X−M₁)^{T}Σ₁⁻¹(X−M₁)−b(X−M₂)^{T}Σ₂⁻¹(X−M₂)+c(log(|Σ₁|/|Σ₂|) where a, b, c are constants, Σ₁ is a covariance matrix of class statistics of the previously stored consistent training pairs, and Σ₂ is a covariance matrix of class statistics of the previously stored inconsistent training pairs.

A next step includes testing 210 the comparison from the comparing step 206 against a predetermined threshold to determine if the representation of the training pair is consistent. If the representation of training pair is found consistent 214, a next step includes storing 216 a combined representation of the training pair as a valid training pair. However, if the representation of the training pair is found not consistent, a next step would include rejecting 212 the training pair and returning to the beginning to obtain new speech samples 202.

In review, the present invention provides an apparatus and method that compares the consistency of statistics of input training speech against the class statistics of previously stored speech. The novel aspects of the present invention are the use of statistics (mean, covariance) of a Viterbi score of test utterances in comparison to similar statistics of stored utterances, including the statistics of utterances that are not similar to the input speech. Moreover, the present invention utilizes the statistics of previously stored inconsistent speech to further enhance voice recognition accuracy.

While specific components and functions of the speech recognition system are described above, fewer or additional functions could be employed by one skilled in the art and be within the broad scope of the present invention. The invention should be limited only by the appended claims.

What is claimed is:

1. A method for detecting inconsistent voice training in a speech recognition system, the method comprising the steps of:
inputting data representing a first spoken phrase and a second spoken phrase defining a voice recognition training pair;
comparing a representation of the training pair with a collection of data of previously stored training pairs;
testing the comparison from the comparing step against a predetermined threshold to determine if the representation of the training pair is consistent; and
storing a combined representation of the training pair as a valid training pair if the representation of the training pair is consistent.

2. The method of claim 1, wherein the comparing step includes the collection of data of previously stored consistent training pairs, M, being defined by a mean vector of the previously stored consistent training pairs.

3. The method of claim 1, wherein after the inputting step, further comprising the step of converting the training pair into separate feature sets.

4. The method of claim 3, wherein the converting step includes determining a Viterbi path score for each of the separate feature sets to provide a feature vector representation of the training pair.

5. The method of claim 3, wherein the converting step includes determining a Viterbi path score for each of the separate feature sets to define a feature vector X=[x₁, x₂]^{T} where x₁ and x₂ are the respective Viterbi path scores of the associated feature sets of the training pair.

6. The method of claim 5, wherein, in the comparing step, the collection of data of previously stored training pairs includes a mean vector, M, of previously stored consistent training pairs, and includes the comparison (X−M)^{T}Σ⁻¹(X−M) where Σ is a diagonalized covariance matrix of class statistics of the previously stored consistent training pairs.

7. The method of claim 3, wherein the converting step includes determining a Viterbi path score for each of the separate feature sets to define a feature vector X=[x₁, x₂, y₁, y₂]^{T} where x₁ and x₂ are the respective Viterbi path scores of the associated feature sets of the training pair, and y₁ and y₂ are reference path scores.

8. The method of claim 7, wherein, in the comparing step, the collection of data of previously stored training pairs includes a mean vector, M₁, of previously stored consistent training pairs and a mean vector, M₂, of previously stored inconsistent training pairs, and includes the comparison a(X−M₁)^{T}Σ₁⁻¹(X−M₁)−b(X−M₂)^{T}Σ₂⁻¹(X−M₂)+c(log(|Σ₁|/|Σ₂|) where a, b, c are constants, Σ₁ is a covariance matrix of class statistics of the previously stored consistent training pairs, and Σ₂ is a covariance matrix of class statistics of the previously stored inconsistent training pairs.

9. A method for detecting inconsistent voice training in a speech recognition system, the method comprising the steps of:
inputting data representing a first spoken phrase and a second spoken phrase defining a voice recognition training pair;
converting the training pair into separate feature sets and determining a Viterbi path score for each of the separate feature sets to define a feature vector of the training pair;
comparing the feature vector with a collection of data of previously stored training pairs;
testing the comparison from the comparing step against a predetermined threshold to determine if the representation of the training pair is consistent;
storing a combined representation of the training pair as a valid training pair if the representation of the training pair is consistent; and
rejecting the training pair if the representation of the training pair is not consistent.

10. The method of claim 9, wherein the converting step includes defining the feature vector as X=[x₁, x₂]^{T} where x₁ and x₂ are the respective Viterbi path scores of the associated feature sets of the training pair.

11. The method of claim 10, wherein, in the comparing step, the collection of data of previously stored training pairs includes a mean vector, M, of previously stored consistent training pairs, and includes the comparison (X−M)^{T}Σ⁻¹(X−M) where Σ is a diagonalized covariance matrix of class statistics of the previously stored consistent training pairs.

12. The method of claim 9, wherein the converting step includes defining the feature vector as X=[x₁, x₂, y₁, y₂]^{T} where x₁ and x₂ are the respective Viterbi path scores of the associated feature sets of the training pair, and y₁, and y₂ are reference path scores.

13. The method of claim 12, wherein, in the comparing step, the collection of data of previously stored training pairs includes a mean vector, M₁, of previously stored consistent training pairs and a mean vector, M₂, of previously stored inconsistent training pairs, and includes the comparison a(X−M₁)^{T}Σ₁⁻¹(X−M₁)−b(X−M₂)^{T}Σ2⁻¹(X−M₂)+c(log(|Σ₁|/|Σ₂|) where a, b, c are constants, Σ₁ is a covariance matrix of class statistics of the previously stored consistent training pairs, and _{Σ}₂ is a covariance matrix of class statistics of the previously stored inconsistent training pairs.

14. An apparatus for detecting inconsistent voice training in a speech recognition system, comprising:
a receiver that inputs data representing a first spoken phrase and a second spoken phrase defining a voice recognition training pair and outputs a representation of the training pair;
a memory for storing training pairs;
a comparator that inputs the representation of the training pair from the receiver, compares it with a collection of data of training pairs previously stored in the memory, and outputs a comparison; and
a detector that inputs the comparison and tests it against a predetermined threshold to determine if the representation of the training pair is consistent, wherein if the representation of training pair is found consistent, a combined representation of the training pair is stored in the memory as a valid training pair.

15. The apparatus of claim 14, wherein the collection of data of previously stored consistent training pairs, M, is defined by a mean vector of the previously stored consistent training pairs.

16. The apparatus of claim 14, wherein the receiver converts the training pair into separate feature sets.

17. The apparatus of claim 16, wherein a Viterbi path score is determined for each of the separate feature sets to provide a feature vector representation of the training pair.

18. The apparatus of claim 16, wherein a Viterbi path score is determined for each of the separate feature sets to define a feature vector X=[x₁, x₂]^{T} where x₁ and x₂ are the respective Viterbi path scores of the associated feature sets of the training pair.

19. The apparatus of claim 18, wherein the collection of data of previously stored training pairs includes a mean vector, M, of previously stored consistent training pairs, and the comparison is (X−M)^{T}Σ⁻¹(X−M) where Σ is a diagonalized covariance matrix of class statistics of the previously stored consistent training pairs.

20. The apparatus of claim 16, wherein a Viterbi path score is determined for each of the separate feature sets to define a feature vector X=[x₁, x₂, y₁, y₂]^{T} where x₁ and x₂ are the respective Viterbi path scores of the associated feature sets of the training pair, and y₁ and y₂ are reference path scores, and wherein the collection of data of previously stored training pairs includes a mean vector, M₁, of previously stored consistent training pairs and a mean vector, M₂, of previously stored inconsistent training pairs, and the comparison is a(X−M₁)^{T}Σ₁⁻¹(X−M₁)−b(X−M₂)^{T}Σ₂⁻¹(X−M₂)+c(log(|Σ₁|/|Σ₂|) where a, b, c are constants, Σ₁ is a covariance matrix of class statistics of the previously stored consistent training pairs, and Σ₂ is a covariance matrix of class statistics of the previously stored inconsistent training pairs.
